(19) United States
(12) Patent Application Publication
(10) Pub. No.: US 2022/0195916 A1
(43) Pub. Date: Jun. 23, 2022

(54) SPOOL VALVE HAVING TWO SPOOL VALVE PARTS FOR A LONGITUDINALLY ADJUSTABLE CONNECTING ROD

(71) Applicants: IWIS MOTORSYSTEME GMBH & CO. KG, München (DE); AVL LIST GMBH, Graz (AT)

(72) Inventors: Malte HELLER, München (DE); Stefanie BEZNER, Geltendorf (DE)

(21) Appl. No.: 17/606,411

(22) PCT Filed: May 4, 2020
(86) PCT No.: PCT/AT2020/060181

§ 371 Date: Oct. 25, 2021

(30) Foreign Application Priority Data
May 3, 2019 (AT) A 50402 2019
May 15, 2019 (AT) A 50440 2019

(51) Int. Cl. F02B 75/04

(52) U.S. Cl. CPC F02B 75/045

(57) ABSTRACT

A longitudinally adjustable connecting rod for a piston engine having a hydraulic control device for adjusting the effective length of the longitudinally adjustable connecting rod is provided. The hydraulic control device comprises a hydraulic control valve which has a control cylinder, a spool valve and at least one drain valve that can be actuated by the spool valve, wherein the spool valve comprises a control piston, which is displaceably guided in the control cylinder and to which hydraulic control pressure can be applied, and a slide plunger. The spool valve comprises two spool valve parts which can be separately manufactured and rigidly joined together for the intended use of the spool valve. Moreover, the invention relates to a spool valve for the hydraulic control valve of a longitudinally adjustable connecting rod and to a piston engine having at least one such longitudinally adjustable connecting rod.

The present invention relates to a longitudinally adjustable connecting rod for a piston engine having a hydraulic control device for adjusting the effective length of the longitudinally adjustable connecting rod, wherein the control device comprises a hydraulic control valve which has a control cylinder, a spool valve and at least one drain valve that can be actuated by the spool valve, and wherein the spool valve comprises a control piston which is displaceably guided in the control cylinder and to which hydraulic control pressure can be applied, and a slide plunger. The invention furthermore relates to a spool valve for the hydraulic control valve of a longitudinally adjustable connecting rod and a piston engine with a longitudinally adjustable connecting rod.

In internal combustion engines with reciprocating pistons efforts are being made to change the compression ratio during the operation and to adapt it to the respective operating state of the engine to improve the thermal efficiency of the internal combustion engine. As the compression ratio rises, thermal efficiency increases, however, a compression ratio which is too high can lead to an unintentional self-ignition of the piston engine. Not only does such a premature combustion of the fuel lead to an unsteady run and the so-called knocking of the engine, but it can also lead to damages of the components of the engine. In a part-load operation, the risk of self-ignition is lower, so that a higher compression ratio is possible.

To realize a variable compression ratio (VCR), there are different solutions by which the position of the crank pin of the crankshaft or the piston pin of the reciprocating piston is changed, or the effective length of the connecting rod is varied. Here, there are solutions each for a continuous and a discontinuous adjustment of the components. A continuous length adjustment of the distance between the piston pin and the crankshaft pin permits a sliding adjustment of the compression ratio to the respective operating point, and thus an optimal efficiency of the internal combustion engine. In contrast, in a discontinuous adjustment of the connecting rod length with only a few stages, constructive and operational advantages result and nevertheless permit, compared to a conventional piston engine, a significant improvement of the efficiency as well as corresponding savings of the consumption and emission of pollutants.

EP 1 426 584 A1 describes a discontinuous adjustment of the compression ratio for a piston engine in which an eccentric connected with the piston pin of the reciprocating piston permits an adaptation of the compression ratio, the fixing of the eccentric in the respective end positions of the pivot region being accomplished by means of a mechanical arrest. In contrast, DE 10 2005 055 199 A1 discloses a longitudinally adjustable connecting rod by which different compression ratios can be realized, the eccentric being fixed in its position by two cylinder-piston units and the hydraulic pressure difference of the supplied engine oil.

WO 2015/055582 A2 shows a longitudinally adjustable connecting rod with telescopically insertable connecting rod parts, the adjustment piston provided at the first connecting rod part subdividing the cylinder of the second connecting rod part into two pressure chambers. The two pressure chambers of this cylinder-piston unit are supplied with engine oil via check valves, wherein pressurized engine oil is only located in one pressure chamber at a time. If the longitudinally adjustable connecting rod is in the long position, there is no engine oil in the upper pressure chamber, while the lower pressure chamber is completely filled with engine oil. In operation, a pulling force is then absorbed by the mechanical contact with the upper limit stop of the adjustment piston. Acting pressure force is transmitted to the lower pressure chamber filled with engine oil via the piston face. Since the check valve of this chamber prevents the return of the engine oil, the pressure of the engine oil increases so that the connecting rod is hydraulically locked in this direction. In the short position of the longitudinally adjustable connecting rod, the ratios in the cylinder-piston unit are reversed. The lower pressure chamber is empty while the upper pressure chamber is filled with engine oil. Correspondingly, a pulling force causes a pressure increase in the upper chamber and a hydraulic locking of the longitudinally adjustable connecting rod, while a pressure force is absorbed by the mechanical stop of the adjustment piston.

The connecting rod length of this longitudinally adjustable connecting rod can be adjusted in two steps, wherein one of the two pressure chambers each is emptied by bridging the corresponding check valve in the supply conduit via a corresponding return conduit. Engine oil flows through these return conduits between the pressure chamber and the supply with engine oil whereby the respective check valve loses its effect. The two return conduits are opened and closed by a hydraulic control device, wherein at any time, maximally one return conduit is open, and the other one is closed. The actuator for switching the two return conduits is hydraulically activated by the supply pressure of the engine oil which is supplied via corresponding hydraulic medium conduits in the connecting rod and the bearing of the crankshaft pin in the second connecting rod. The active adjustment of the connecting rod length is then accomplished by selectively emptying the pressure chamber filled with engine oil utilizing the gas and mass forces acting on the connecting rod, while the other pressure chamber is simultaneously supplied with engine oil via the corresponding check valve and is hydraulically locked.

A further longitudinally adjustable connecting rod is known e. g. from WO 2016/203047 A1. To adjust the effective length of the connecting rod, a spool valve with a centrically arranged control piston is used therein which is pretensioned by a spool valve spring in one direction. The spool valve comprises a control piston to which hydraulic control pressure can be applied, and a two-part slide plunger which has a conical control contour at the respective ends to open the corresponding drain valves.

When used in a piston engine, a longitudinally adjustable connecting rod is naturally subjected to very high acceleration forces which also have to be considered when designing the hydraulic control device. Correspondingly, the hydraulic control valves are configured and manufactured for the respective application of the longitudinally adjustable connecting rod and the respective efficiency of the piston engine to realize a secure adjustment of the effective length of the longitudinally adjustable connecting rod.

In the development of modern piston engines, apart from the safe functionality of the individual components, there is a requirement to realize a significant improvement of the efficiency and corresponding savings of the consumption and emission of pollutants. Simultaneously, an inexpensive manufacture of the components and assembly of the piston engine must be ensured. Here, the installation space for such connecting rods in modern piston engines is limited both in the longitudinal direction of the connecting rod (axially) and also radially which has to be taken into consideration in the construction of the hydraulic control device and in particular in the construction of the hydraulic control valve.

It is therefore the object of the present invention to optimize a longitudinally adjustable connecting rod of the type mentioned in the beginning such that the hydraulic control valve can be manufactured securely and inexpensively and be easily employed in a generic longitudinally adjustable connecting rod.

According to the invention, this object is achieved in that the control piston of the spool valves comprises two spool valve parts which can be separately manufactured and rigidly joined together when the spool valve is used as intended.

Depending on the construction of a piston engine, the load of the longitudinally adjustable connecting rod due to gas and mass forces acting on the connecting rod in operation and due to oil pressure variations in the hydraulic medium supply of the control valve by the movement of the connecting rod, conventional spool valves are especially constructed for the specific demands of the respective engine type. In this context, conventional control valves and their components are manufactured in correspondingly low piece numbers. With respect to the required tolerances for a safe function of the hydraulic control valve, such spool valves for conventional longitudinally adjustable connecting rods are designed in one piece, wherein the great diameter differences necessitate a complex processing. In one embodiment of the spool valve according to the invention, by providing two spool valve parts, a substantially easier and cheaper manufacture is permitted without impairing the function of the spool valve or its movable guidance in the control cylinder. By manufacturing the spool valve parts as separate components, they can be employed in different combinations for various engine types and thereby be manufactured in higher piece numbers. Furthermore, by their separate manufacture, the material removal rate is clearly reduced, whereby the consumption of expensive raw materials and the required processing time are clearly reduced.

In a variation of the embodiment of a longitudinally adjustable connecting rod according to the invention, the spool valve and an additional mass rigidly connected with the spool valve are provided which permits an adaptation of a spool valve to the respective engine type which can be manufactured in higher piece numbers. In other words, in this variant, the spool valve forms a first spool valve part, and the additional mass forms a second spool valve part. Preferably, the density of the material of the additional mass is then equal to or greater than the density of the material of the control piston and/or the slide plunger. Correspondingly, a spool valve provided with a more complex contour can be inexpensively manufactured in higher numbers, and the respective adaptation to the particular engine type can be realized via an additional mass rigidly connected to the spool valve. Apart from a clear reduction of the manufacturing costs, the embodiment according to the invention also fulfils the concept of carry-over parts aimed at in the automobile industry.

To realize a preferably high number of different engine types with the concept of carry-over parts of a particular spool valve design and corresponding additional masses, the spool valve can be a mass-optimized spool valve, wherein the mass of the spool valve is reduced by the material choice of the slide plunger and/or by a switching contour of the slide plunger provided with at least one constriction, and/or by the mass of the slide plunger which corresponds to maximally 0.93 times, preferably maximally 0.85 times of the hull volume of the slide plunger multiplied by the density of steel (7.85 g/mm³).

For the mass reduction of the spool valve, in this way, either light-weight materials and/or material removals in the region of the slide plunger can be utilized. The hull volume of the switching contour is here the volume of the switching contour of the slide plunger on the basis of the length of the switching contour and the largest cross-section of the switching contour. With respect to this theoretical mass of the hull volume of the switching contour, corresponding recesses, grooves and indentations in the region of the switching contour reduce its actual mass. By the mass reduction, the mass forces acting on the spool valve, which are substantially independent of the speed of the internal combustion engine and of the concrete arrangement of the spool valve in the connecting rod, can be reduced.

In an alternative or supplemental embodiment, the spool valve can be a mass-optimized spool valve, wherein the mass of the spool valve is reduced by the material choice of the control piston and/or by a blind hole bore provided in the control piston which preferably extends into the slide plunger. Apart from the positive effect of the constructive measure to manufacture the control piston from a lighter material, in particular with respect to the large diameter of the control piston displaceably guided in the control cylinder and the large volume of the control piston caused thereby, a blind hole bore can also be provided in the control piston to reduce the overall mass of the control piston and thus also the mass of the spool valve. If the required demands on the strength of the spool valve are considered, such a blind hole bore can also extend into the slide plunger.

For a secure fixing of the additional mass to the spool valve, the additional mass is preferably fixed to the spool valve by means of a press fit, a threaded joint, or by means of a safety means. A simple safety means is, for example, a circlip arranged on the slide plunger and firmly fixing the additional mass in the direction of the control piston. Apart from the secure fixing of these different measures for a fastening with the additional mass to the spool valve, these assembly options include various advantages and disadvantages and can also be employed in combination. While an additional safety means, for example a circlip, facilitates an arrangement of the additional mass on the slide plunger of the spool valve, the secure fixing of the additional mass by means of a press fit is in particular advantageous in cylindrical control pistons hollow in one side, and a threaded joint during the assembly is in general easy to handle.

In a further embodiment, the control piston is preferably arranged on the front side at the slide plunger and includes at least one control pressure face that can be subjected to the hydraulic control pressure and defines a control pressure chamber within the control cylinder. Here, the control pressure face that can be subjected to the hydraulic control pressure is preferably arranged at the front side at the control piston of the spool valve. Such a front-side design of the spool valve and the corresponding hydraulic control valve permit, apart from an altogether simple construction, also a safe function and exact control of the longitudinally adjustable connecting rod. By the front-side arrangement of the control piston, the control cylinder can be embodied as a simple stepped hole, and the conduits provided therein can be embodied as simple holes. Furthermore, the control piston arranged at the front side permits a clear division between the at least one drain valve and the control pressure chamber defined by the control pressure face to actuate the spool valve. Apart from the constructively simple design of the spool valve and the control cylinder, a control piston arranged at the front side can also keep the demands on the tolerances of the components of the control valve and on the sealing of the control piston with respect to the control cylinder low.

In one variant of the invention, the slide plunger extends from the control piston arranged at the front side in the direction of the spool valve axis through the control cylinder, wherein the slide plunger is preferably embodied to be rotationally symmetric to the spool valve axis. In a further variant of the invention, the longitudinal axis of the slide plunger and the spool valve axis are designed to be parallel with respect to each other or to coincide.

For a particular simple transmission of the axial movement of the spool valve in the direction of the spool valve axis, the slide plunger can have a switching contour to actuate the at least one drain valve. Here, the switching contour can be embodied as a flat surface of the slide plunger extending in a straight or oblique line with or without indentations and projections.

In a particular variant, the spool valve is arranged inclined with respect to the longitudinal direction of the connecting rod and inclined with respect to the normal of the longitudinal direction of the connecting rod, wherein the spool valve axis is preferably arranged at an angle between 15° and 75°. In other words, the spool valve axis is arranged inclined with respect to the longitudinal axis of the connecting rod. In addition to the spool valve optimized by means of the additional mass, the inclined arrangement of the spool valve with respect to the longitudinal direction of the connecting rod and with respect to the normal to the longitudinal direction of the connecting rod can, with an advantageous selection of the angle, further reduce the negative influences of the inertia of the hydraulic medium in the hydraulic medium conduits and in the components of the hydraulic control device. Thereby, troubles and malfunctions in the activation of the control device can be avoided. Furthermore, by the inclined arrangement of the spool valve, interfering influences on the other components of the hydraulic control device and the longitudinally adjustable connecting rod whose function may be impaired in particular by the mass forces considerably increasing at high speeds can also be minimized.

In an advantageous embodiment, at least two drain valves actuated by the spool valve are provided, wherein the at least two drain valves can preferably be alternately actuated. Depending on the position of the control valve, maximally one of the two drain valves is opened, so that hydraulic media can escape either from the first pressure chamber or the second pressure chamber of the control device, in particular from a double-acting cylinder-piston unit, of the longitudinally adjustable connecting rod. In the meantime, the other pressure chamber can simultaneously fill with hydraulic medium as a consequence of the gas and mass forces acting in the piston engine during the reciprocating motion of the connecting rod which cause, by means of the appearing pulling effect, an opening of the return valve associated with the other pressure chamber. As this pressure chamber is increasingly filled, hydraulic medium is discharged from the opened pressure chamber whereby the effective length of the longitudinally adjustable connecting rod changes. Depending on the design of the hydraulic control device and on the operating state of the piston engine, a plurality of strokes of the connecting rod can be required until the change of the length of the connecting rod is completed. Advantageously, the drain valves include spring-loaded valve bodies, preferably valve balls, which are moved in the direction of the lifting axis of the valve body against the spring preload via a suited transmission element, for example transmission pins or transmission balls, to open the drain valve.

For a safe function and a simple design of the drain valves, the at least two drain valves can be arranged inclined with respect to the spool valve axis, preferably perpendicular to the spool valve axis. Here, the arrangement of the drain valves relates to the opening direction of the valve bodies in the drain valves. This inclined arrangement of the drain valves permits, apart from a simple construction of the hydraulic control valve, also altogether small dimensions of the connecting rod with a corresponding mass reduction. In an alternative embodiment, the at least two drain valves can be arranged on opposite sides of the spool valve axis, preferably perpendicular to the spool valve axis, to permit a very compact construction of the hydraulic control valve and a very slim design of the connecting rod.

In a further embodiment, a limit stop flange can be provided between the switching contour of the slide plunger and the control piston arranged on the front side, wherein a constricting annular groove is preferably provided between the limit stop flange and the control piston. Thereby, this region between the switching contour of the slide plunger and the control piston is also mass-optimized. Such a construction of the spool valve permits a simple assembly in a correspondingly shaped bore without the insertion of receiving sockets or adapters. Only the control pressure chamber formed by the control piston has to be sealed by a corresponding closure which can also simultaneously form a limit stop for the control piston.

In a preferred embodiment, the hydraulic control device comprises a readjusting spring to retain the spool valve in a first starting position or readjust it to the first starting position, the readjusting spring being preferably arranged around the spool valve. The readjusting spring permits to provide two different switching positions in the hydraulic control valve without providing an active readjusting mechanism, additional pressure chambers, or supply lines. Thereby, the manufacturing costs can be kept low with a simultaneous increase of functional reliability. Furthermore, such a readjusting spring can be easily adapted to different control pressures or applications of the control valve without having to change the overall construction of the hydraulic control device or even the longitudinally adjustable connecting rod. Here, an arrangement of the readjusting spring around the spool valve reduces the required installation space for the control valve and simultaneously also the manufacturing efforts.

In one embodiment of the longitudinally adjustable connecting rod, the connecting rod includes two connecting rod parts, the first connecting rod part including the first connecting rod big end, and the second connecting rod part including the second connecting rod big end, and the first connecting rod part being preferably telescopically movable with respect to the second connecting rod part in the longitudinal direction of the connecting rod to adjust the distance between the piston pin and the crankshaft pin. In contrast to connecting rods with eccentrics, two connecting rod parts movable with respect to each other in the longitudinal direction of the connecting rod permit a stable construction and a safe and permanent operation of the longitudinally adjustable connecting rod.

Here, at least one cylinder-piston unit hydraulically connected to the hydraulic control device can be provided to move the first connecting rod part relative to the second connecting rod part, wherein preferably the first connecting rod part is connected with an adjustment piston of the cylinder-piston unit, and the second connecting rod part includes a cylinder bore of the cylinder-piston unit. This permits, apart from a very robust construction of the longitudinally adjustable connecting rod, also simple and inexpensive connecting rod parts, wherein the adjustment piston of the first connecting rod part is preferably connected directly with the piston rod and the connecting rod head with the first connecting rod big end, and the second connecting rod part includes a housing in which, apart from the cylinder bore, the hydraulic control device is also provided.

In a further variant of the embodiment of a longitudinally adjustable connecting rod according to the invention, the spool valve includes a first spool valve part which comprises the control piston and a first slide plunger section, and a second spool valve part which comprises a second slide plunger section. In conventional longitudinally adjustable connecting rods, spool valves of titanium or ceramic materials are employed in the hydraulic control valves which are often not designed to be rotationally symmetric. Both the manufacture and the assembly of such spool valves in the hydraulic control valve of conventional longitudinally adjustable connecting rods are correspondingly complicated and expensive. Such spool valves have a relatively thin slide plunger with corresponding switching contours and a control piston with an essentially larger diameter on which the control pressure of the hydraulic medium and a re-adjusting force act.

Advantageously, the first spool valve part and/or the second spool valve part are designed to be rotationally symmetric. Thereby, a swift and easy manufacture is possible.

It is here in this variant also advantageous for the spool valve parts to be made of different materials, wherein preferably the first spool valve part at least primarily consists of a material having a lower density than the material of which the second spool valve part consists at least primarily. In this manner, the manufacture can be further optimized and the spool valve designed to match the function.

Advantageously, the spool valve parts are connected here to each other via a non-positive and/or a positive connection. This means that the spool valve parts may be connected non-positively, e. g. screwed or pressed with each other, and as an alternative or in addition, a positive connection, for example gluing, welding or any other connection, may be provided. These types of connection are established, can be quickly performed and have a high durability.

In a variant of the embodiment with two spool valve parts, the control piston is arranged at one end of the first spool valve part, and at the opposite end of the first spool valve part—in the direction of the spool valve axis—preferably at the end of the first spool valve section, a limit stop flange is arranged. If the spool valve is used for actuating two drain valves, the limit stop flange can serve to define one of the switching positions.

Advantageously, here, too, an additional constricting annular groove is furthermore provided between the limit stop flange and the control piston. Thereby, this region between the switching contour of the slide plunger and the control piston can also be mass-optimized. Such a construction of the spool valve permits a simple assembly in a correspondingly shaped bore in an assembled state of the spool valve without the insertion of receiving sockets or adapters. Only the control pressure chamber formed by the control piston has to be sealed by a corresponding closure which can also simultaneously form a limit stop for the control piston. To further reduce the weight of the spool valve, a longitudinal bore extending in parallel to the spool valve axis is advantageously embodied within the first spool valve part and extends at least over a portion, preferably over the total length of the first spool valve part. Preferably, the longitudinal bore is embodied to extend from the end of the first spool valve part opposite the control piston in the direction of the control piston, either as a blind hole bore or as a through bore.

Apart from the weight reduction, the connection of the spool valve parts can also be facilitated thereby: In a variant, the second spool valve part includes a connection region for this which can be inserted into and preferably rigidly positioned in the longitudinal bore for joining or connecting the spool valve parts. For example, the interior of the longitudinal bore can be provided with an internal thread, and the connection region is embodied as a corresponding external thread, so that a swift and easy connection is possible. As an alternative, the connection region can also be fixed in the longitudinal bore via a press fit.

Advantageously, the second spool valve part includes at least one switching contour by which the at least one drain valve can be actuated, wherein the switching contour is preferably embodied to be rotationally symmetric to the spool valve axis. Thereby, a simple actuation of the drain valve or drain valves can be ensured.

In a variant, the control cylinder has a low-pressure section with a first diameter and a high-pressure section with a second diameter, wherein the first diameter is preferably larger than the second diameter. Thereby, the actuation of the spool valve can be separated from medium flowing through the drain valves, or the two regions can be provided with different pressures. For example, the low-pressure section can be designed for pressures from 1 to 20 bar, while the high-pressure section is suited for pressures from 100 to 5000 bar.

To prevent a penetration of media between the pressure regions, the second spool valve part advantageously has a sealing section at its end facing the first spool valve part, which partially penetrates into the low-pressure section when the spool valve is used as intended, but does not completely leave the high-pressure section at any time of its use. In particular, the sealing section can include a diameter corresponding to the diameter of the high-pressure region, so that a sealing effect is achieved.

In a further variant, the slide plunger section and/or the second slide plunger section is designed as a mass-optimized slide plunger section, wherein the mass of the slide plunger section is reduced due to the material choice of the slide plunger section or due to a contour of the second slide plunger section provided with at least one constriction whose mass corresponds to maximally 0.93 times, preferably maximally 0.85 times the hull volume of the contour of the second slide plunger section multiplied by the density of steel (7.85 g/mm³). To realize a special spool valve design with a suited control piston for a preferably high number of different engine types corresponding to the concept of carry-over parts common in the automotive field, the spool valve can be such a mass-optimized spool valve. For the mass reduction of the spool valve, either lightweight materials and/or material removals in the region of the slide plunger sections can be utilized. The hull volume of the switching contours is here the volume of the switching contour of the slide plunger on the basis of the length of the switching contour and the largest cross-section of the switching contour. With respect to this theoretical mass of the hull volume of the switching contour, corresponding recesses, grooves and indentations in the region of the switching contour and the shank reduce its actual mass. By the mass reduction of the slide plunger, the mass forces acting on the spool valve, which are substantially independent of the speed of the internal combustion engine and of the concrete arrangement of the spool valve in the connecting rod, can be reduced.

In a useful embodiment, the spool valve is arranged inclined with respect to the longitudinal direction of the connecting rod and/or inclined with respect to the normal of the longitudinal direction of the connecting rod, preferably at an angle between 15° and 75°. Here, the inclined arrangement of the spool valve with respect to the longitudinal direction of the connecting rod and/or with respect to the normal to the longitudinal direction of the connecting rod can further reduce the negative influences of the inertia of the hydraulic medium in the hydraulic medium conduits and in the components of the hydraulic control device by an advantageous selection of the angle. Both troubles and malfunctions in the activation of the control device and interfering influences on the further components of the hydraulic control device can be minimized by the inclined arrangement of the spool valve.

In a preferred embodiment, the hydraulic control device comprises a readjusting spring to retain the spool valve in a first starting position or readjust it to the first starting position, wherein the readjusting spring is preferably arranged at least around the first slide plunger section and is supported at the control piston. The readjusting spring permits to provide two different switching positions in the hydraulic control valve without providing an active readjusting mechanism, additional pressure chambers, or supply lines. Thereby, the manufacturing costs can be kept low with a simultaneous increase of functional reliability. Furthermore, such a readjusting spring can be easily adapted to different control pressures or applications of the control valve without having to change the overall construction of the hydraulic control device or even the longitudinally adjustable connecting rod. Here, an arrangement of the readjusting spring around the slide plunger reduces the required installation space for the control valve and simultaneously also the manufacturing efforts.

In an advantageous embodiment, at least two drain valves actuated by the spool valve are provided, wherein the at least two drain valves can be preferably actuated alternately. Depending on the position of the spool valve, maximally one of the two drain valves is opened, so that hydraulic medium can escape either from the first pressure chamber or the second pressure chamber of the control device, in particular a double-acting cylinder-piston unit, of the longitudinally adjustable connecting rod. In the meantime, the other pressure chamber can simultaneously fill with hydraulic medium as a consequence of the gas and mass forces acting in the piston engine during the reciprocating motion of the connecting rod which cause, by means of the appearing pulling effect, an opening of the return valve associated with the other pressure chamber. As this pressure chamber is increasingly filled, hydraulic medium is discharged from the opened pressure chamber whereby the effective length of the longitudinally adjustable connecting rod changes. Depending on the design of the hydraulic control device and on the operating state of the piston engine, a plurality of strokes of the connecting rod can be required until the change of the length of the connecting rod is completed. Advantageously, the drain valves include spring-loaded valve bodies, preferably valve balls, which are moved in the direction of the lifting axis of the valve body against the spring preload via a suited transmission element, for example transmission pins or transmission balls, to open the drain valve.

For a safe function and a simple design of the drain valves, the at least two drain valves can be arranged inclined with respect to the spool valve axis, preferably perpendicular to the spool valve axis. Here, the arrangement of the drain valves relates to the opening direction of the valve bodies in the drain valves. This inclined arrangement of the drain valves permits, apart from a simple construction of the hydraulic control valve, also altogether smaller dimensions of the connecting rod with a corresponding mass reduction.

The invention furthermore relates to a spool valve for a longitudinally adjustable connecting rod according to the above-described embodiments with a control piston which is displaceable in a control cylinder and to which hydraulic control pressure can be applied, and with a slide plunger, wherein an additional mass can be rigidly connected to the spool valve. Thus, the spool valve consists of two spool valve parts, a first spool valve part comprising the control piston and the slide plunger, and the second spool valve part being formed by the additional mass.

The invention furthermore relates to a constructed spool valve for a longitudinally adjustable connecting rod according to the above-described embodiments with a first spool valve part with a control piston which is displaceable in a control cylinder and to which hydraulic control pressure can be applied, and a first slide plunger section of a slide plunger, as well as with a separately manufactured second spool valve part with a second slide plunger section of a slide plunger.

Moreover, variants are possible in which the spool valve is formed of a first spool valve part, a second spool valve part and one or more additional masses rigidly connected to one of the parts.

Corresponding to the general concept of carry-over parts, such spool valves permit the use of different spool valve parts manufactured in high piece numbers. On the one hand, a spool valve for different piston engines can be easily adapted to the specific valve mass required for each individual engine type by means of the additional mass. On the other hand, by a corresponding mass adaptation of the individual spool valve parts by means of the concept of equal slide plungers, a plurality of different engine types can be provided with a specifically adapted spool valve at low manufacturing costs. Thereby, oil pressure variations in a longitudinally adjustable connecting rod due to the connecting rod movement can be compensated. Simultaneously, by means of the concept of equal slide plungers for a plurality of different engine types and the specific adaptation of the valve mass by means of an additional mass or the embodiment of the valve parts, the manufacturing costs can be significantly reduced.

In a further aspect, the invention relates to a piston engine with at least one engine cylinder, a reciprocating piston moving in the engine cylinder, and at least one adjustable compression ratio in the engine cylinder, and with at least one longitudinally adjustable connecting rod connected to the reciprocating piston according to the above-described embodiments. Preferably, all reciprocating pistons of the piston engine are equipped with such a longitudinally adjustable connecting rod, and the control device of the longitudinally adjustable connecting rod is connected with the engine oil hydraulics of the piston engine. The fuel saving of such a piston engine can be considerable if the compression ratio is correspondingly adjusted in response to the respective operating state. By means of the hydraulic control device and the spool valve with the additional mass, an inexpensive and robust control of the longitudinally adjustable connecting rod is permitted.

Below, non-restricting embodiments of the invention will be illustrated more in detail with reference to exemplary drawings. In the drawings:

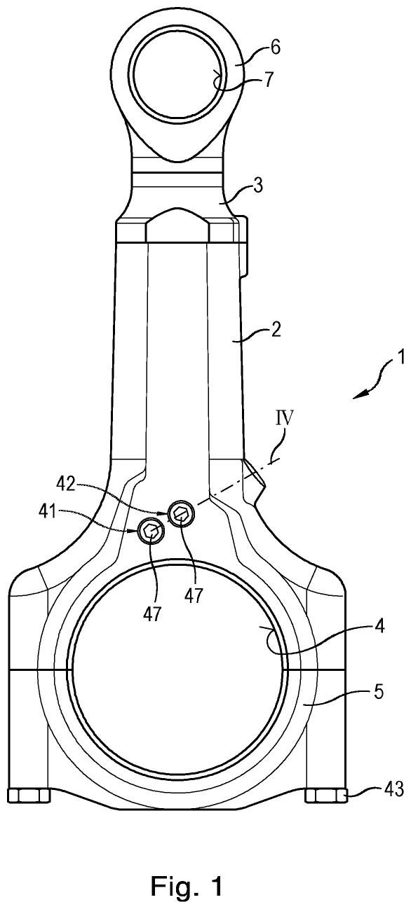

FIG. 1 shows a plan view of a longitudinally adjustable connecting rod according to the invention,

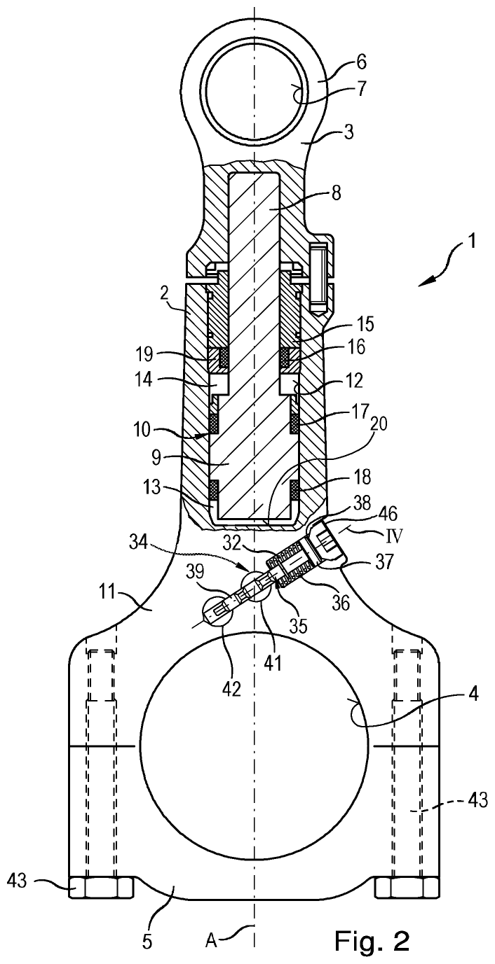

FIG. 2 shows a schematic view of the partially cut open longitudinally adjustable connecting rod of FIG. 1,

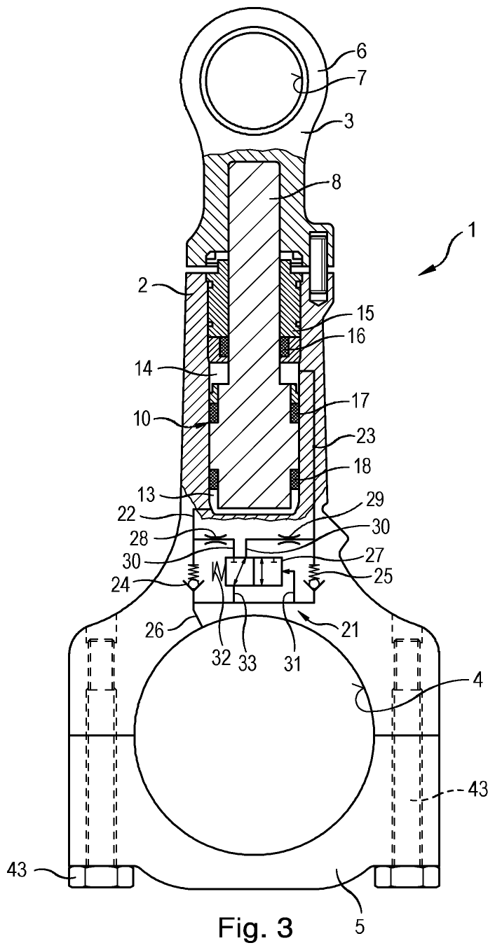

FIG. 3 shows a schematic view of the longitudinally adjustable connecting rod of FIG. 1 with a schematic representation of the hydraulic control valve,

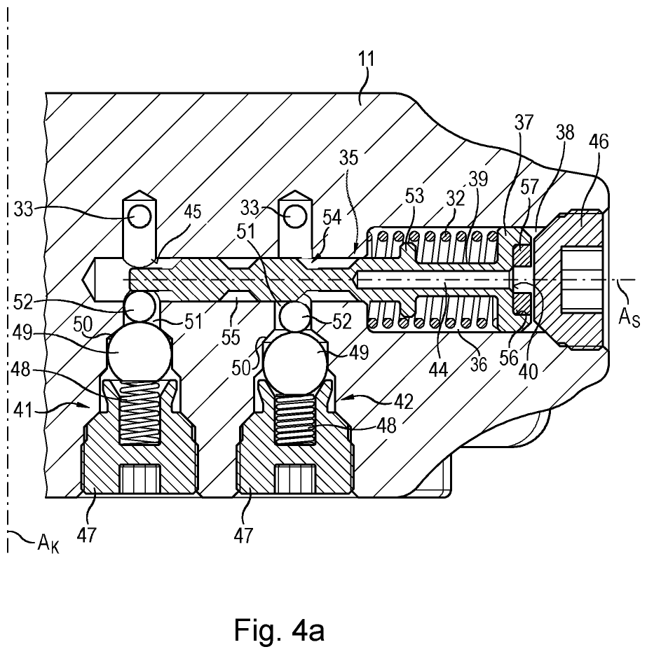

FIG. 4a shows a first variant of a longitudinally adjustable connecting rod of FIG. 1 in an enlarged sectional view along line IV,

FIG. 4b shows a second variant of a longitudinally adjustable connecting rod of FIG. 1 in an enlarged sectional view along line IV,

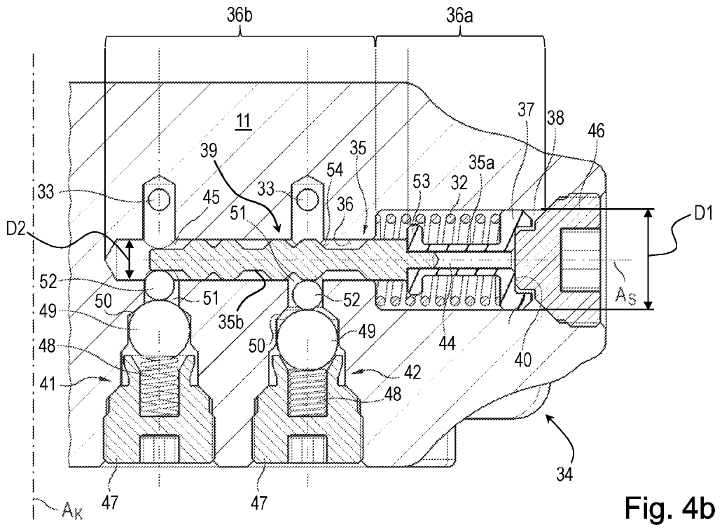

FIG. 5a shows an enlarged sectional representation of the spool valve of FIG. 4a with an additional mass pressed in,

FIG. 5b shows an enlarged sectional view of the spool valve of FIG. 4a with an additional mass pressed on in a second embodiment,

FIG. 5c shows an enlarged sectional view of the spool valve of FIG. 4a with an additional mass pressed on in a third embodiment,

FIG. 5d shows an enlarged sectional view of the spool valve of FIG. 4a with an additional mass screwed on,

FIG. 5e shows an enlarged sectional view of the spool valve of FIG. 4a with an additional mass secured on the slide plunger,

FIG. 5f shows an enlarged sectional view of the spool valve of FIG. 4a with an additional mass pressed on with an integrated limit stop;

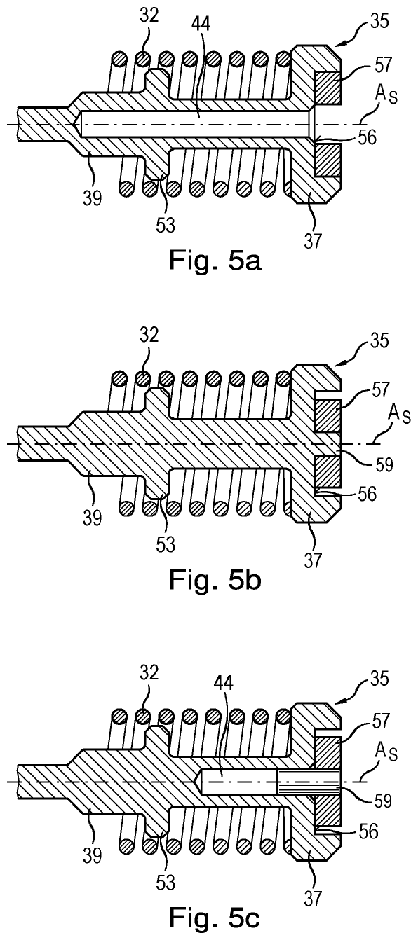

FIG. 6a shows a perspective representation of a spool valve of FIG. 4b in an assembled state;

FIGS. 6b and 6c show a second spool valve part and a first spool valve part of the spool valve of FIG. 6a in a separated state;

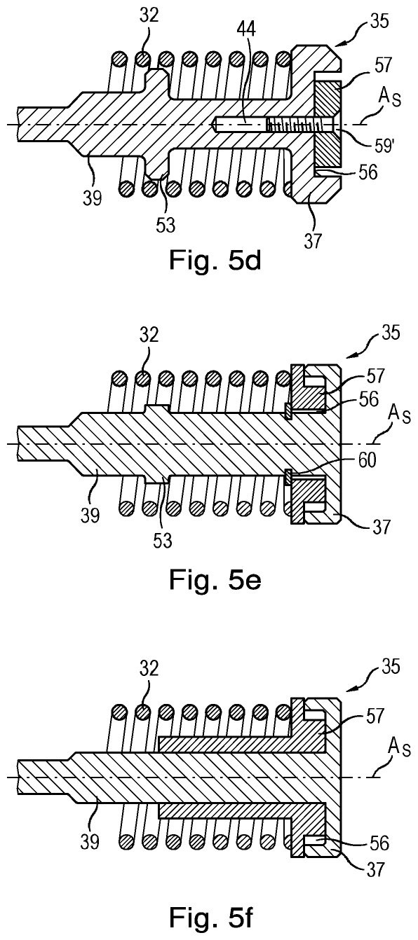

FIG. 7 shows a sectional view of the spool valve of FIG. 6a along a spool valve axis; and

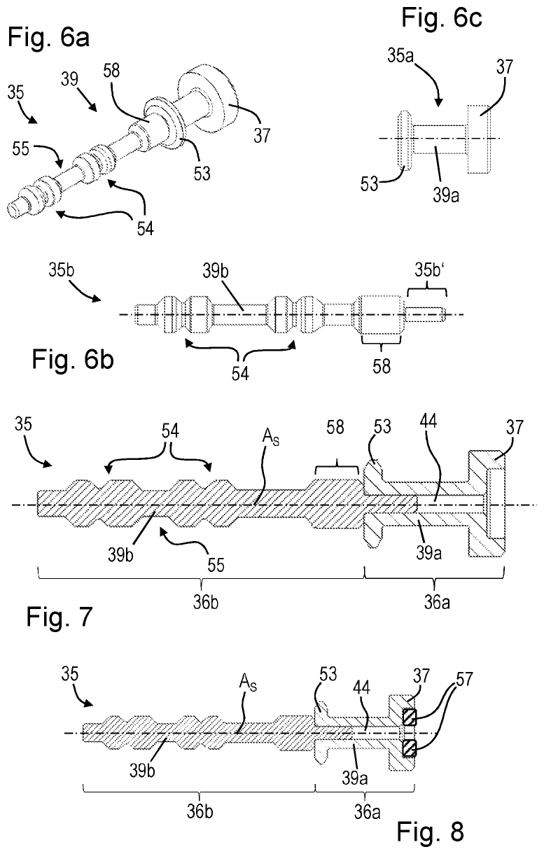

FIG. 8 shows a sectional view of a variant of the spool valve of FIG. 6a with another additional mass along a spool valve axis.

The longitudinally adjustable connecting rod 1 represented in FIG. 1 comprises two mutually telescopically movable connecting rod parts 2, 3. The lower connecting rod part 2 arranged at the bottom in the representation of the longitudinally adjustable connecting rod 1 in FIG. 1 has a large connecting rod big end 4 by which the longitudinally adjustable connecting rod 1 is mounted on the crankshaft (not depicted) of the piston engine. To this end, at the lower connecting rod part 2, a bearing shell 5 is furthermore arranged which forms, together with the lower region of the lower connecting rod 2 also formed like a bearing shell, the large connecting rod big end 4. The bearing shell 5 and the lower connecting rod part 2 are connected to each other by means of connecting rod bolts 43. The upper connecting rod part 3 has a connecting rod head 6 with a small connecting rod big end 7 which receives the piston pin (not depicted) of the reciprocating piston in the piston engine.

As can be clearly seen in FIG. 2, the connecting rod head 6 is connected, via a piston rod 8, to an adjustment piston 9 of an adjustment device of the longitudinally adjustable connecting rod 1 embodied as a cylinder-piston unit 10. Here, the connecting rod head 6 is usually screwed or welded to the piston rod 8 while the adjustment piston 9 and the piston rod 8 are integrally formed. This permits to arrange, easily and without any damage and before the assembly of the upper connecting rod part 3, a cylinder cover 15 of the cylinder-piston unit, and a rod seal 16 on the piston rod 8 and piston seals 17, 18 at the adjustment piston 9. In a non-depicted embodiment, the piston rod 8 and the connecting rod head 6 are integrally formed while the adjustment piston 9 is screwed onto the piston rod 8.

The upper connecting rod part 3 is guided telescopically in the lower connecting rod part 2 via the adjustment piston 9 to adjust the distance between the piston pin of the reciprocating piston received in the small connecting rod big end 7 and the crankshaft of the piston engine received in the large connecting rod big end 4 to thus adapt the compression ratio of the piston engine to the respective operating state. This distance between the piston pin of the reciprocating piston and the crank-shaft of the piston engine is referred to as effective length in the present disclosure. The adaptation permits to operate the piston engine in part load with a higher compression ratio than at full load and thus increase the efficiency of the engine. In a housing 11 of the lower connecting rod part 2, a cylinder 12 is embodied in the upper region which is introduced in the housing 11 of the lower connecting rod part 2 as a cylinder bore or cylinder sleeve. In the cylinder 12, the adjustment piston 9 of the upper connecting rod part 3 is arranged movably in the longitudinal direction or along the longitudinal axis A of the connecting rod 1 in order to embody, together with the cylinder 12 and the cylinder cover 15, the cylinder-piston unit 10. The adjustment piston 9 is represented in a central position in FIG. 2 in which the adjustment piston 9 divides the cylinder 12 into two pressure chambers 13 and 14. The piston rod 8 extends from the adjustment piston 9 through the upper pressure chamber 14 and the cylinder cover 15 which delimits the housing 11 and the cylinder 12 to the top.

A rod seal 16 is provided at the cylinder cover 15 and is retained by a circlip 19 at the transition between the piston rod 8 and the cylinder cover 15. The rod seal 16 surrounds the piston rod 8 and seals the upper pressure chamber 14 with respect to the surrounding area. The two piston seals 17, 18 arranged on the adjustment piston 9 seal the adjustment piston 9 with respect to the cylinder 12 and thus also the pressure chambers 13, 14 with respect to each other. The circlip 19 forms, together with the cylinder cover 15, an upper limit stop against which the adjustment piston 9 abuts in the upper position, the long position of the longitudinally adjustable connecting rod 1, while in the lower position (short position) of the longitudinally adjustable connecting rod 1, the adjustment piston 9 abuts against the lower limit stop formed by the cylinder bottom 20.

Below, with reference to the hydraulic interconnection of a control device 21 represented in FIG. 3 for supplying the adjustment device embodied by the cylinder-piston unit 10 will be illustrated more in detail. The two pressure chambers 13, 14 are each connected with the engine oil circuit of the piston engine by separate hydraulic medium lines 22, 23 and separate check valves 24, 25 and a common oil supply conduit 26 which ends in the large connecting rod big end 4. If the longitudinally adjustable connecting rod 1 is in the long position, there is no engine oil in the upper pressure chamber 14, while the lower pressure chamber 13 is completely filled with engine oil. During the operation, the connecting rod 1 is alternately loaded by tensile loads and pressure due to the mass or acceleration and gas forces, respectively. In the long position, the pulling force is absorbed by the mechanical contact of the adjustment piston 9 with the circlip 19. The length of the connecting rod 1 is not changed thereby. An acting pressure force is transmitted to the lower pressure chamber 13 filled with engine oil via the piston face. Since the check valve 25 associated with the lower pressure chamber 13 prevents the engine oil from streaming out, the pressure of the engine oil increases dramatically and prevents a change of the connecting rod length. Thereby, the longitudinally adjustable connecting rod 1 is hydraulically locked in this moving direction.

In the short position of the longitudinally adjustable connecting rod 1, the ratios are inversed. The lower pressure chamber 13 is completely empty, and a pressure force is absorbed at the cylinder bottom 20 by the mechanical limit stop of the adjustment piston 9, while the upper pressure chamber 14 is filled with engine oil, so that a pulling force onto the longitudinally adjustable connecting rod 1 causes a pressure increase in the upper pressure chamber 14 and thus causes a hydraulic locking.

The connecting rod length of the longitudinally adjustable connecting rod 1 represented here can be adjusted in two stages by emptying one of the two pressure chambers 13, 14 and filling the respective other pressure chamber 13, 14 with engine oil. To this end, one of the check valves 24, 25 each is bridged by the hydraulic control device 21, so that the engine oil can flow out of the previously filled pressure chamber 13, 14. The respective check valve 24, 25 thus loses its effect. To this end, the hydraulic control device 21 comprises a 3/2-way valve 27 whose two switchable connections 30 are each connected to a hydraulic medium line 22, 23 of the pressure chambers 13, 14 via a throttle 28, 29. A first connection 30 is associated with the lower pressure chamber 13, and a second connection 30 with the upper pressure chamber 14.

In the process, the 3/2-way valve 27 is actuated by the pressure of the engine oil which is supplied to the 3/2-way valve 27 via a control pressure line 31 connected to the oil supply conduit 26. The readjustment of the 3/2-way valve 27 is accomplished by a readjusting spring 32. The two switchable connections 30 of the 3/2-way valve 27 are connected to a stream-out conduit 33 which discharges the engine oil removed from the pressure chambers 13, 14 to the oil supply conduit 26 from where it is available for filling the respective other pressure chamber 14, 13 or can be discharged to the surrounding area via the large connecting rod big end 4. In the preferential position of the 3/2-way valve 27 represented in FIG. 3, the upper pressure chamber 14 is open. As an alternative, the stream-out conduit 33 can directly dis-charge the engine oil to the surrounding area.

In the 3/2-way valve 27, one of the switchable connections 30 each is open, so that the corresponding pressure chamber 13, 14 is emptied, while the other connection 30 is closed. In case of a change of the switching position of the 3/2-way valve 27 by the application of a higher control pressure via the control pressure line 31, or by a readjustment via the readjusting spring 32 at a decreasing control pressure, the formerly opened connection 30 is closed, and the formerly closed connection 30 is opened. Consequently, the engine oil under high pressure streams out of the pressure chamber 13, 14 formerly filled with engine oil via the respective hydraulic medium line 22, 23 and the corresponding throttle 28, 29 through the opened connection 30 of the 3/2-way valve 27 and the stream-out conduit 33 to the surrounding area, in particular into the oil supply conduit 26. Simultaneously, by the mass and gas forces acting in a piston engine during the reciprocation of the connecting rod 1, a pulling effect is formed in the formerly empty pressure chamber 14, 13, by which the corresponding check valve 24, 25 opens, so that the formerly empty pressure chamber 14, 13 fills with engine oil. As the filling of this pressure chamber 14, 13 increases, the engine oil is increasingly discharged from the other pressure chamber 13, 14 via the opened connection 30, whereby the length of the connecting rod 1 changes. Depending on the embodiment of the longitudinally adjustable connecting rod 1 and the hydraulic control device 21 and the operating state of the piston engine, a plurality of strokes of the connecting rod 1 may be required until the pressure chamber 14, 13 locked by the hydraulic control device 21 is completely filled with engine oil and the other opened pressure chamber 13, 14 is completely emptied, and thus the maximally possible change of the length of the connecting rod 1 is reached.

The hydraulic control valve 34 shown in FIG. 2 is embodied as sliding valve with a control cylinder 36 and a mushroom-shaped spool valve 35 displaceably arranged in the control cylinder 36. The spool valve 35 has a control piston 37 arranged at the front side which forms, together with the control cylinder 36, a control pressure chamber 38 arranged at the front side of the spool valve 35. The control cylinder 36 is embodied in the housing 11 of the lower connecting rod part 2 as a stepped hole inclined with respect to the longitudinal axis A of the connecting rod 1 and also with respect to the normal to the longitudinal axis A of the connecting rod 1. At the open end of the control cylinder 36, a closing cap 46 is provided which seals the control pressure chamber 38 with respect to the surrounding area.

The control pressure chamber 38 is supplied with hydraulic medium under control pressure from the oil supply conduit 26 (see FIG. 3) via the control pressure line 31. On the back of the front-side control piston 37 facing away from the control pressure chamber 38, a slide plunger 39 extends in the lower end of the control cylinder 36 which is embodied as a low-pressure chamber 45, which is why a contacting or contactless seal is provided between the front-side control piston 37 and the control cylinder 36. At an upper section of the slide plunger 39 facing the control piston 37, the readjusting spring 32 is arranged around the slide plunger 39, while at the lower end of the slide plunger 39, a switching contour 54 for opening and closing the drain valves 41, 42 is embodied to uniformly lift the respective valve body 49 from the valve seat 50 of the first and the second drain valves 41, 42 with as little expenditure of force as possible, and to open the respective drain valve 41, 42.

With reference to FIGS. 4a and 5a-f, the construction and the function of a first variant of the hydraulic control valve 34 for a connecting rod 1 according to the invention will be illustrated more in detail below.

FIG. 4a shows an enlarged sectional view of the hydraulic control valve 34 along the section line IV represented in FIGS. 1 and 2. Here, the head of this mushroom-shaped spool valve 35 is embodied as a control piston 37 with a front-side countersunk indentation 56 to reduce the mass of the spool valve 35. The slide plunger 39 of the spool valve 35 has, in the upper region facing the control piston 37, an upper section with a smaller diameter around which the readjusting spring 32 is arranged, and in the lower region, a switching contour 54 which, apart from guiding the spool valve 35, is also engaged with the two drain valves 41, 42 to alternately open the associated pressure chambers 13, 14 from the closed state. Both drain valves 41 and 42 have the same design which is why the corresponding elements will only be described with reference to the first drain valve 41. The drain valve 41 comprises a screw plug 47 which is screwed into a corresponding threaded seat opening in the housing 11 of the lower connecting rod part 4. In the screw plug 47, a valve spring 48 is arranged which acts on a spherical valve body 49. The spherical valve body 49 interacts with a conical valve seat 50 which ends in a valve opening 51. In the valve opening 51, a closing body 52 which is also spherical is arranged. The first drain valve 41 is shown in the closed position in FIG. 4a, and the second drain valve 42 is shown in the open position. Between the slide plunger 39 of the spool valve 35 and the control cylinder 36, the valve pressure chamber 45 is here embodied via which the hydraulic medium streaming out from the upper pressure chamber 14 via the opened second drain valve 42 is discharged to the oil supply conduit 26 in order to provide the streaming-out engine oil directly for filling the lower pressure chamber 13.

The actuation of the drain valves 41 and 42 is accomplished by means of the spool valve 35. The spool valve 35 is hydraulically in communication with the engine oil circuit via the control pressure line 31. An increase of the control pressure in the engine oil circuit acts on the control pressure face 40 of the control piston 37 on the front side. Thereby, the control piston 37 is moved in the direction of the valve pressure chamber 45 against the action of the readjusting spring 32. The spool valve 35 has a limit stop flange 53 which predefines the second position. To delimit the control pressure chamber 38 defined by the control piston 37, a closing cap 46 is provided. The spool valve 35 has a switching contour 54 with two elevations with a rhombic cross-section which each act on the corresponding closing bodies 52 which then move the corresponding valve body 49 as a consequence. In the position of the spool valve 35 represented in FIG. 4a, there is sufficient clearance between the slide plunger 39 or the switching contour 54 and the closing body 52 of the first drain valve 41, so that the valve body 49 is securely seated on the valve seat 50. The closing body 52 associated in the second drain valve 42 has a lifted position in the position of the spool valve 35 represented in FIG. 4a. The closing body 52 thus acts on the valve body 49 of the second drain valve 42 and lifts the valve body 49 and the corresponding valve spring 48 from the valve seat 50. The second drain valve 42 is opened thereby. Correspondingly, the engine oil can flow out of the upper pressure chamber 14, while the lower pressure chamber 13 is locked.

If the spool valve 35 moves, by the increasing control pressure of the engine oil, in the control pressure chamber 38 in the direction of the valve pressure chamber 45, the closing body 52 of the second drain valve 42 slides downwards at the switching contour 54 into a relieved position and releases the corresponding valve body 46, so that the valve spring 48 presses the valve body 49 onto the valve seat 50. Subsequently, the closing body 52 of the first drain valve 41 slides upwards at the switching contour 54, whereby the corresponding valve body 49 is pressed away from the axis A_{S} of the spool valve 35. Simultaneously, the corresponding valve spring 48 is compressed and the valve body 49 is lifted from the valve seat 50. Thereby, the control valve 34 is pressed into the second valve position resulting in the short position of the longitudinally adjustable connecting rod 1.

At the spool valve 35 shown in FIG. 4a, various measures for optimizing the mass of the spool valve 35 are provided. In the central region of the switching contour 54 provided at the slide plunger 39, a groove-like constriction 55 is provided which is arranged between the two elevated regions of the switching contour 54 which correlate with the two drain valves 41, 42 and permit the guidance of the spool valve 35 in the control cylinder 36. Moreover, the upper section of the slide plunger 39 is provided with a smaller diameter in the form of a constricting annular groove in the region of the readjusting spring 32. Furthermore, from the side of the control piston 37, a bore 44 extending into the slide plunger 39 and, in the region of the control piston 37 itself, a countersunk indentation 56 are provided. The bore 44 here preferably extends in parallel or along a longitudinal axis A_{S} of the control piston 37.

The basic diameter of the groove-like constriction 55 approximately corresponds to the lower diameter of the slide plunger 39 beyond the switching contour 54. Here, the transition between the countersunk indentation 56 and the blind hole bore 44 in the slide plunger 39 can be chamfered. The mass reduction achieved by these measures results each from the saved volume of the slide plunger 39 or the control piston 37, respectively, multiplied by the mass of steel (7.85 g/mm³). Due to the weight or volume reduction purposefully made for this spool valve 35, the mass of the spool valve 35 can be very clearly reduced, so that by a selective addition of an additional mass 57, the spool valve 35 of the hydraulic control valve 34 can be adjusted to very diverse cases of application.

The acceleration forces acting on the spool valve 35 depend on the respective design of the longitudinally adjustable connecting rod 1 and the hydraulic control device 21, but also on the respective piston engine. Via the acceleration forces, considerable forces can therefore act on the readjusting spring 32 due to the total mass of the spool valve 35. The control pressure chamber 38 also has to be selected such that a displacement of the spool valve 35 is ensured despite the influence of mass. Therefore, for a longitudinally adjustable connecting rod 1 according to the invention, it is intended to keep the mass of the spool valve 35 below 1 g to permit an optimal adaptation to the respective piston engine via the additional mass 57. Preferably, the density of the material of the additional mass 57 is here equal to or greater than the density of the material of the control piston 37 and/or the slide plunger 39. The additional mass 57 can here consist of only one material or a mixture of several materials.

The enlarged sectional view of the upper section of the spool valve 35 in FIG. 5a clearly shows the arrangement of the additional mass 57 in the counter-sunk indentation 56 of the control piston 37. The additional mass 57 is here tightly pressed into the countersunk indentation 56 to securely move it together with the spool valve 35 within the control cylinder 36. Next to the countersunk indentation 56, the bore 44 can be recognized here again in the upper section of the spool valve 35 which extends from the countersunk indentation 56 into the slide plunger 39 beyond the limit stop flange 53. A spool valve 35 mass-optimized in such a way can be provided with different additional masses 57 for an optimal adaptation to the respective longitudinally adjustable connecting rod 1 and the corresponding piston engine, so that the same spool valve 35 of the control piston 37 and slide plunger 39 can be employed for different engine types corresponding to the concept of carry-over parts.

In FIG. 5b, a second embodiment of a spool valve 35 according to the invention with a pressed-on additional mass 57 is shown in an enlarged sectional view. In contrast to the embodiment shown in FIG. 4a and FIG. 5a, the additional mass 57 is not pressed on at the outer wall and the countersunk indentation 56, but onto a pin 59 projecting coaxially with respect to the spool valve axis A_{S} in the countersunk indentation 56. Apart from the mass optimization reduced by the pin 59 with the countersunk indentation 56, here, too, the upper part of the slide plunger 39 is embodied with a small diameter up to the limit stop flange 53.

The enlarged sectional view in FIG. 5c shows a third embodiment of a mass-optimized spool valve 35. Apart from the smaller diameter of the upper section of the slide plunger 39 between the control piston 37 and the limit stop flange 53, this embodiment, too, has a countersunk indentation 56 in the control piston 37 and a shortened bore 44 from the countersunk indentation 56 into the upper parts of the slide plunger 39. The additional mass 57 is in this embodiment rigidly pressed with the pin 59 which in turn is securely pressed into the bore 44 to securely fasten the additional mass 57, which is here supplemented by the mass of the pin 59, to the mass-optimized spool valve 35. The larger sectional view of the spool valve 35 in FIG. 5d shows a further similar embodiment. In contrast to the above embodiments, in this mass-optimized spool valve 35, the additional mass 57 is screwed to the mass-optimized spool valve 35 with a screw 59′. Here, the screw 59′ engages with a threaded bore 44 to securely connect the additional mass 57 with the mass-optimized spool valve 35.

FIG. 5e shows a completely different embodiment of the mass-optimized spool valve 35 in an enlarged sectional view, wherein the additional mass 57 is arranged on the back side of the control piston 37 facing the slide plunger 39 and is there retained by means of a circlip 60 in the region of the control piston 37. Apart from the reduced diameter of the upper section of the slide plunger 39 between the limit stop flange 53 and the control piston 37, the control piston 37 here has a countersunk indentation 56 introduced from the inside to keep the mass of the spool valve 35 low and permit an optimal adaptation to the respective piston engine via the additional mass 57.

Another possibility of arranging the additional mass 57 on the back side of the control piston 37 facing the slide plunger 39 is represented in FIG. 5f. In this embodiment, the shank of the slide plunger 39 is embodied altogether with a small diameter, and the control piston 37 is provided with a countersunk indentation 56 from the inside to embody the spool valve 35 from the control piston 37 and the slide plunger 39 with a preferably low mass. The additional mass 57 for optimally adapting the spool valve 35 to the respective piston engine is pressed onto the shank of the slide plunger 39 and extends into the countersunk indentation 56 in the control piston 37. The opposite free end of this additional mass 57 simultaneously functions as a limit stop for the spool valve 35 against the effect of the readjusting spring 32 in the direction of the valve pressure chamber 45.

Like the previous embodiments of the spool valve 35 in FIGS. 5a to 5e, here, too, this mass-optimized spool valve 35 is provided with an additional mass 57 which is permanently and securely fastened to the spool valve 35 of the control piston 37 and the slide plunger 39 to make the respective mass-optimized spool valves 35 usable for a large number of different engine types by optimally adapting, via an additional mass 57, the spool valve 35 to the respective conditions in the internal combustion engine and the longitudinally adjustable connecting rod 1.

FIG. 4b shows an enlarged sectional view of a second variant of the hydraulic control valve 34 along the section line IV represented in FIGS. 1 and 2. Here, a two-part spool valve 35 with a slide plunger 39 is represented with a first spool valve part 35a and a second spool valve part 35b adjacent in the longitudinal direction along the spool valve axis A_{S}. The head of this mushroom-shaped spool valve 35 on the side of the first spool valve part 35a is embodied as a cup-like control piston 37, followed by a first slide plunger section 39a. This is followed by the second spool valve part 35b with the second slide plunger section 39b. The spool valve axis A_{S} is substantially normal to the axis A_{K} of the (non-depicted) crankshaft. The two spool valve parts 35a, 35b can be manufactured separately, but are rigidly joined together as represented when used as intended.

The first slide plunger section 39a of the first spool valve part 35a has, in its upper region, a section with a larger diameter around which the readjusting spring 32 is arranged.

In the lower region of the second slide plunger section 39b, the switching contour 54 is furthermore provided which is, apart from guiding the spool valve 35, also engaged with the two drain valves 41, 42 to alternately open the associated pressure chambers 13, 14 from the closed state. Both drain valves 41 and 42 have the same design and have been already described in detail in connection with FIG. 4a. The valve pressure chamber 45 is here embodied between the second slide plunger section 39b of the spool valve 35 and the control cylinder 36.

Corresponding to the function and design of the spool valve 35, it follows that the control cylinder 36 includes two regions: On the side of the control pressure chamber 38, there is the low-pressure section 36a, and in the high-pressure chamber 45, where the oil is supplied from the pressure chambers 13, 14, there is the high-pressure section 36b.

The two sections 36a, 36b have different diameters: The low-pressure section 36a has a first diameter D1 which is larger than the second diameter D2 of the high-pressure section 36b.

The mutual sealing of the sections 36a, 36b is accomplished in that the second spool valve part 35b has a sealing section 58 at its end facing the first spool valve part 35a which partially penetrates into the low-pressure section 36a when the spool valve 35 is used as intended, but does not completely leave the high-pressure section 36b at any time during its use. The diameter of the second spool valve part 35b in the region of the sealing section 58 substantially corresponds to the second diameter D2, so that a sealing effect is achieved.

The actuation of the drain valves 41 and 42 is accomplished by means of the spool valve 35. The spool valve 35 is hydraulically in communication with the engine oil circuit via the control pressure line 31. An increase of the control pressure in the engine oil circuit acts on the control pressure face 40 of the control piston 37 on the front side. Thereby, the control piston 37 is moved in the direction of the valve pressure chamber 45 against the action of the readjusting spring 32. The slide plunger 39 has, in the region of the first slide plunger section 39a, a flange 53 predefining the second position.

To delimit the control pressure chamber 38 defined by the control piston 37, a closing cap 46 is provided. The spool valve 35 has, in the region of the second slide plunger section 39b, switching contours 54 with two elevations having a rhombic shape in the cross-section (cutting plane in parallel to the spool valve axis A_{S}) which each act on the corresponding closing bodies 52 which then move the corresponding valve bodies 49 as a result. In the position of the spool valve 35 represented in FIG. 4b, there is sufficient clearance between the slide plunger 39 or the switching contour 54 and the closing body 52 of the first drain valve 41, so that the valve body 49 is securely seated on the valve seat 50. The closing body 52 associated in the second drain valve 42 has a lifted position in the position of the spool valve 35 represented in FIG. 4b. The closing body 52 thus acts on the valve body 49 of the second drain valve 42 and lifts the valve body 49 and the corresponding valve spring 48 from the valve seat 50. The second drain valve 42 is opened thereby. Correspondingly, the engine oil can flow out of the upper pressure chamber 14, while the lower pressure chamber 13 is locked.

At the slide plunger 39 of the spool valve 35 shown in FIG. 4b, too, especially at the second slide plunger section 39b, various measures for optimizing the mass of the slide plunger 39 can be provided. In the central region of the switching contour 54 provided at the second slide plunger section 39b, a trapezoidal constriction 55 is provided which is arranged between the two elevated regions of the switching contour 54 which correlate with the two drain valves 41, 42 and permit the guidance of the spool valve 35 within the control cylinder 36. Moreover, the upper section of the slide plunger 39, especially the first slide plunger section 39a, can be provided with a smaller diameter in the region of the readjusting spring 32. Furthermore, the longitudinal bore 44 already described in connection with FIG. 4a is embodied within the first spool valve part 35a. This longitudinal bore 44 extends at least over a portion of the first spool valve part 35a, in the exemplified embodiment according to FIG. 4b at least as a blind hole bore starting from the side of the first spool valve part 35a facing away from the control piston 37 in the direction of the control piston 37. FIG. 4b shows the longitudinal bore as a through bore. Due to the weight or volume reductions purposefully made for this spool valve 39, the mass of the spool valve 39 can be very clearly reduced, so that the spool valve 35 of the hydraulic control valve 34 can be adjusted for very diverse cases of application.

The acceleration forces acting on the spool valve 35 depend on the respective design of the longitudinally adjustable connecting rod 1 and the hydraulic control device 21, but also on the respective piston engine. Therefore, considerable forces may act on the spool valve 35 and the readjusting spring 32 via the acceleration forces due to the total mass of the spool valve 35, which is why the mass of the spool valve 35 should be preferably kept small and be configured for the respective application to permit an optimal adaptation to the respective piston engine.

This situation as well as the adaptability to various demands is permitted by the embodiment of the spool valve 35 with two spool valve parts 35a, 35b described below.

FIG. 6a shows a perspective representation of a spool valve 35 in an assembled state. The spool valve 35 is designed to be rotationally symmetric throughout. Between the region with the switching contours 54 and the control piston 37, the limit stop flange 53 is represented. On the side of the limit stop flange 53 facing away from the control piston 37, there is the sealing section 58. One can see that the diameter of the slide plunger 39 is smaller on the one side of the limit stop flange 53 than on the other side facing the control piston 37. This is in particular due to the design of the high-pressure section 36b of the control cylinder 36.

FIG. 6b shows the second spool valve part 35b with the switching contours 54 and the sealing section 58. FIG. 6c shows the first spool valve part 35a with the control piston 37 and the limit stop flange 53. The two parts 35a, 35b can be made of different materials permitting a further weight optimization. Preferably, the first spool valve part 35a is here made of a lighter material having a lower density than the material of the second spool valve part 35b, or is primarily made of such a material if one or both parts 35a, 35b consist of several materials.

In FIG. 7, in a sectional view of the spool valve 35, it can be seen that the two spool valve parts 35a, 35b are inserted into each other, wherein the second spool valve part 35b includes a connection region 35b′ which is inserted in a longitudinal bore 44 embodied within the first spool valve part 35a. The longitudinal bore 44 extends over at least a portion of the first spool valve part 35a, but is, in the present exemplified embodiment, designed as a through bore.

The connection of the spool valve parts 35a, 35b can be accomplished by a non-positive connection, for example if the interior of the longitudinal bore 44 is provided with an internal thread and the connection region 35b′ of the second spool valve part 35b includes an external thread. It is also possible to provide a press fit or to supplementally perform a positive connection—gluing, welding or soldering.

FIG. 8 now shows a variant wherein a spool valve 35 with two spool valve parts 35a, 35b inserted into each other is provided and additionally, in the region of the control piston 37, an additional mass 57 is arranged in a countersunk indentation 56 of the control piston 37. The additional mass 57 is here rigidly pressed into the countersunk indentation 56 to be able to securely move it together with the spool valve 35 within a control cylinder 36. Next to the countersunk indentation 56, the bore 44 can be recognized here again in the upper section of the spool valve 35 which extends from the countersunk indentation 56 into the slide plunger 39 beyond the limit stop flange 53. Thereby, a particularly mass-optimized spool valve 35 can be realized for an optimal adaptation to the respective longitudinally adjustable connecting rod 1 and the corresponding piston engine. Moreover, further different additional masses 57 can be provided, or the embodiments described in FIGS. 5a to 5f can be used individually or in combination.

The invention thereby permits the mass optimization of a spool valve 35 for longitudinally adjustable connecting rods 1, wherein, corresponding to the concept of carry-over parts, the same spool valve 35 of the control piston 37 and the slide plunger 39 can be employed for various applications or engine types, respectively.

1. A longitudinally adjustable connecting rod for a piston engine having a hydraulic control device for adjusting the effective length of the longitudinally adjustable connecting rod, wherein the hydraulic control device comprises a hydraulic control valve which has a control cylinder, a spool valve and at least one drain valve that can be actuated by the spool valve, and wherein the spool valve comprises a control piston which is displaceably guided in the control cylinder and to which hydraulic control pressure can be applied, and a slide plunger, wherein the spool valve comprises two spool valve parts which can be separately manufactured and rigidly joined together for the intended use of the spool valve.

2. The longitudinally adjustable connecting rod according to claim 1, wherein the spool valve and an additional mass rigidly connected with the spool valve are provided.

3. The longitudinally adjustable connecting rod according to claim 1, wherein the spool valve is a mass-optimized spool valve, wherein the mass of the spool valve is reduced by the material choice of the slide plunger and/or by a switching contour of the slide plunger provided with at least one constriction, and/or by the mass of the slide plunger which maximally corresponds to 0.93 times, preferably maximally 0.85 times the hull volume of a switching contour of the slide plunger multiplied by the density of steel (7.85 g/mm³).

4. The longitudinally adjustable connecting rod according to claim 1, wherein the spool valve is a mass-optimized spool valve, wherein the mass of the spool valve is reduced by the material choice of the control piston and/or by a blind hole bore provided in the control piston which preferably extends into the slide plunger.

5. The longitudinally adjustable connecting rod according to claim 1, wherein the additional mass is fastened to the spool valve by means of a press fit, a threaded joint or by means of a securing means.

6. The longitudinally adjustable connecting rod according to claim 1, wherein the control piston is preferably arranged at the front side at the slide plunger and comprises at least one control pressure face to be subjected to the hydraulic control pressure which delimits a control pressure chamber in the control cylinder.

7. The longitudinally adjustable connecting rod according to claim 6, wherein the slide plunger extends from the control piston arranged at the front side in the direction of the spool valve axis (A_{S}) through the control cylinder, wherein preferably the slide plunger is embodied to be rotationally symmetric to the spool valve axis (A_{S}).

8. The longitudinally adjustable connecting rod according to claim 1, wherein the slide plunger has a switching contour to actuate the at least one drain valve.

9. The longitudinally adjustable connecting rod according to claim 1, wherein the spool valve is arranged inclined with respect to the longitudinal axis (A) of the connecting rod and/or inclined with respect to the normal of the longitudinal axis (A) of the connecting rod, wherein preferably the spool valve axis (A_{S}) is arranged at an angle between 15° and 75°.

10. The longitudinally adjustable connecting rod according to claim 1, wherein between a switching contour of the slide plunger and the control piston arranged at the front side, a limit stop flange is provided, wherein preferably between the limit stop flange and the control piston, a constricting annular groove is provided.

11. The longitudinally adjustable connecting rod according to claim 1, wherein the hydraulic control device comprises a readjusting spring to hold the spool valve in a first starting position or to readjust it to the first starting position, wherein preferably the readjusting spring is arranged around the spool valve.

12. The longitudinally adjustable connecting rod according to claim 1, wherein the connecting rod comprises two connecting rod parts, wherein the first connecting rod part comprises a first connecting rod big end to receive a piston pin, and the second connecting rod part comprises a second connecting rod big end to receive a crankshaft pin, and wherein the first connecting rod part is movable with respect to the second connecting rod part in the longitudinal direction (A) of the connecting rod, preferably telescopically, to adjust the distance between the piston pin and the crankshaft pin.

13. The longitudinally adjustable connecting rod according to claim 12, wherein at least one cylinder-piston unit hydraulically connected with the hydraulic control device is provided to move the first connecting rod part relative to the second connecting rod part, wherein preferably the first connecting rod part is connected with an adjustment piston of the cylinder-piston unit, and the second connecting rod part comprises a cylinder bore of the cylinder-piston unit.

14. The longitudinally adjustable connecting rod according to claim 1, wherein a first spool valve part comprises the control piston and a first slide plunger section, and a second spool valve part comprises a second slide plunger section, wherein preferably the spool valve parts are connected to each other via a non-positive and/or a positive connection.

15. The longitudinally adjustable connecting rod according to claim 1, wherein the spool valve parts are made of different materials, wherein preferably the first spool valve part at least primarily consists of a material having a lower density than the material of which the second spool valve part primarily consists.

16. The longitudinally adjustable connecting rod according to claim 14, wherein the control piston is arranged at one end of the first spool valve part, and at the opposite end of the first spool valve part, preferably at the end of the first slide plunger section, a limit stop flange is arranged.

17. The longitudinally adjustable connecting rod according to claim 14, wherein within the first spool valve part, a longitudinal bore extending in parallel to the spool valve axis (A_{S}) is embodied which extends at least over a portion, preferably over the complete length of the first spool valve part.

18. The longitudinally adjustable connecting rod according to claim 17, wherein the longitudinal bore is embodied extending from the end of the first spool valve part opposite the control piston in the direction of the control piston, either as a blind hole bore or as a through bore, wherein preferably the second spool valve part comprises a connection region which is insertable into the longitudinal bore for joining the spool valve parts.

19. The longitudinally adjustable connecting rod according to claim 14, wherein the second spool valve part comprises at least one switching contour by which the at least one drain valve is actuatable, wherein preferably the switching contour is embodied to be rotationally symmetric to the spool valve axis (A_{S}).

20. The longitudinally adjustable connecting rod according to claim 14, wherein the control cylinder comprises a low-pressure section with a first diameter (D1) and a high-pressure section with a second diameter (D2), wherein preferably the second spool valve part comprises a sealing section at its end facing the first spool valve part which, when the spool valve is used as intended, partially penetrates into the low-pressure section, but does not completely leave the high-pressure section at any time of use.

21. The longitudinally adjustable connecting rod according to claim 14, wherein the first slide plunger section and/or the second slide plunger section is designed as a mass-optimized slide plunger section, wherein the mass of the side plunger section is reduced by the material choice of the slide plunger section, or by a contour of the second slide plunger section provided with at least one constriction whose mass corresponds maximally 0.93 times, preferably maximally 0.85 times the hull volume of the contour of the second slide plunger section multiplied by the density of steel (7.85 g/mm³).

22. The longitudinally adjustable connecting rod according to claim 14, wherein the hydraulic control valve comprises a readjusting spring to hold the spool valve in a first starting position or readjust it to the first starting position, wherein the readjusting spring is arranged at least around the first slide plunger section and supports itself at the control piston.

23. A spool valve for a longitudinally adjustable connecting rod according to claim 1, having a control piston which is displaceable in a control cylinder and to which a hydraulic control pressure can be applied, and having a slide plunger, wherein an additional mass is rigidly connectable with the spool valve.

24. An assembled spool valve for a longitudinally adjustable connecting rod according to claim 14, having a first spool valve part with a control piston which is displaceable in a control cylinder and to which a hydraulic control pressure can be applied, and a first slide plunger section of a slide plunger, and with a separately made second spool valve part with a second slide plunger section of a slide plunger.

25. A piston engine with at least one engine cylinder, a reciprocating piston moving in the engine cylinder, and at least one adjustable compression ratio in the engine cylinder, and with at least one longitudinally adjustable connecting rod according to claim 1 connected with the reciprocating piston.
